(19) United States
(12) Patent Application Publication
(10) Pub. No.: US 2011/0022894 A1
(43) Pub. Date: Jan. 27, 2011

(54) METHOD AND SYSTEM FOR DETERMINING AN INDIVIDUAL FAILURE RATE FOR THE EVALUATION OF AN INDIVIDUAL COMPLEX TECHNICAL OPERATING EQUIPMENT

(75) Inventors: Nicolaie FANTANA, Heidelberg (DE); Lars Petterson, Ludvika (SE)

Correspondence Address: BUCHANAN, INGERSOLL & ROONEY PC, POST OFFICE BOX 1404, ALEXANDRIA, VA, 22313-1404, US

(73) Assignee: ABB TECHNOLOGY AG, Zurich (CH)

(21) Appl. No.: 12/855,048

(22) Filed: Aug. 12, 2010

Related U.S. Application Data
(63) Continuation of application No. PCT/EP2009/000644, filed on Jan. 31, 2009.

(30) Foreign Application Priority Data
Feb. 12, 2008 (DE) 10 2008 008 796.3
Oct. 14, 2008 (DE) 10 2008 051 653.8

(51) Int. Cl. G06F 11/00

(52) U.S. Cl. 714/37; 714/E11.004

(57) ABSTRACT

A method and a system are disclosed for determining an individual failure rate for at least one individual technical operating equipment. For the calculation, a data processing unit receives not only the statistical data and characteristics specific for the type of the technical operating equipment, but also valid characteristic data for the individual technical operating equipment are used. Furthermore, additional characteristic values are used that are derived from information about influences by the site of use and the mode of operation of the individual technical operating equipment in an industrial plant. On the basis of the operating equipment type-specific data, an individualized average failure rate can be formed. Characteristic values associated with the individual operating equipment are used for forming a correcting factor. By linking the average failure rate to the correction factor, the individual failure rate is calculated.

### RELATED APPLICATIONS

This application claims priority as a continuation application under 35 U.S.C. §120 to PCT/EP2009/000644, which was filed as an International Application on Jan. 31, 2009 designating the U.S., and which claims priority to German Application 10 2008 008 796.3 filed in Germany on Feb. 12, 2008 and German Application 10 2008 051 653.8 filed in Germany on Oct. 14, 2008. The entire contents of these applications are hereby incorporated by reference in their entireties.

### FIELD

A method and a system are disclosed for determining an individual failure rate for an individual complex technical operating equipment which can be used in a technical system. The method and the system are suitable, for example, to determine a failure rate or reliability which is applicable as an evaluation characteristic variable for a specific time, for example for the current time of the investigation, evaluation and classification of the technical operating equipment, or as a predictor value for a time in the future as well. Complex technical operating equipments for whose evaluation the method and the system are suitable include, for example, power transformers or other complex operating equipment in power stations or electrical power supply systems.

### BACKGROUND INFORMATION

An exemplary method and system as disclosed here can, for example, be used together with or in addition to the method and system for systematic evaluation of evaluation characteristic variables of technical operating equipment” according to EP 1 618 524 A1, the disclosure of which is hereby incorporated by reference in its entirety. While the method known from EP 1 618 524 A1 can be used to form a single overall evaluation characteristic variable for a technical operating equipment by linking evaluation characteristic variables which are based on financially relevant input characteristic variables and on technically relevant input characteristic variables, methods as disclosed herein can provide additional information which relates to the operating equipment reliability and is better validated.

As is known from the article “Zustandsabhängige Bewertung-Neuer Ansatz zum Lebendauermanagement für elektrische Betriebsmittel”—[New approach to lifetime management for electrical operating equipment] published in the ABB Technik 4/2000 Journal, two types of evaluation methods for technical operating equipment are predominantly used in practice, specifically: statistical methods and methods individually matched to individual operating equipment. The statistical methods involve a sufficient amount of reliable data which can be assessed statistically. The technical operating equipment under consideration should in this case have a comparable design, and its failure mechanism should be simple and well known. Relatively complex operating equipments, such as power transformers, may not meet the abovementioned specification. In this case, each unit can be a single item. In contrast, statistical methods involve larger “populations” with operating equipments which are at least technically functionally and structurally comparable. Accordingly, methods such as these are not suitable, or are suitable only to a restricted extent, for example for evaluation of a single power transformer.

Methods are also known for evaluation of technical operating equipments, in which signals and measured values from individual devices are used in order to derive an estimate of the state or of the failure risk from them. In addition, methods and calculation software are known, in which population information, such as data relating to failure rates or reliability, is used to work out the behavior of an average operating equipment, in terms of reliability, failure rate or aging model, that is to say in a similar way to that in statistical methods.

However, methods such as these do not make it possible to determine evaluation characteristic variables such as the failure rate or reliability for an individual complex operating equipment, which evaluation characteristic variables are based both on individual information and on population information. It is also impossible to combine statistical population data with data recorded via sensors or diagnosis or monitoring devices, or which has been determined by evaluation of observations by operating personnel. For example, it is also impossible to derive failure rates, reliability or failure risk—applicable to a specific time—for an individual complex technical operating equipment arranged in a technical system.

### SUMMARY

A method is disclosed for determining an individual failure rate for at least one individual technical operating equipment using a data processing device to perform a computer implemented method comprising: receiving statistical data and characteristic data which are specific for a type of technical operating equipment, at least a portion of the characteristic data being used for the individual technical operating equipment; deriving additional characteristic data from information relating to influences resultant from a point of use and operation method of the individual technical operating equipment in an industrial installation; and determining an individual failure rate based on the statistical data, the characteristic data and the additional characteristic data.

A system is disclosed for determining an individual failure rate for at least one individual technical operating equipment, comprising at least one data processing device; and at least one data memory and an input/output apparatus for interaction with the data processing device, wherein the data processing device includes means for determining an individual failure rate step-by-step under computer program control based on statistical data and characteristics specific for a specified technical operating equipment type, and based on characteristic data which is applicable to the individual technical operating equipment, and based on characteristic data derived from information relating to influences resultant from a point of use and an operation method of the individual technical operating equipment in an industrial installation.

### BRIEF DESCRIPTION OF THE DRAWINGS

These and further advantageous embodiments and refinements of the disclosure are the subject matter of the description of the figures.

Exemplary embodiments as well as further advantageous refinements will be explained and described further with reference to a number of figures, in which:

FIG. 1 shows an illustration of an exemplary method for determining an individual failure rate for an individual technical operating equipment;

FIG. 2 shows an illustration of an exemplary function for forming a status characteristic variable; and

FIG. 3 shows an exemplary system for carrying out a method as disclosed herein.

### DETAILED DESCRIPTION

A method and a system are disclosed for determining a failure rate for evaluation of an individual complex technical operating equipment which is used in a technical system.

A method for determining an individual failure rate for an individual technical operating equipment, as disclosed herein, makes it possible to, for example, evaluate the reliability of a complex technical operating equipment, for example of a power transformer, to be precise taking account of the particular circumstances at its point of use, for example in a power station or an electrical power supply system, and/or taking account of load risks. The method allows not only better evaluation of individual operating equipments, but in this way also provides the basis for better evaluation of the behavior of an overall installation, wherein individual failure rates determined according to methods disclosed herein can represent valuable input data, for example for simulation of the reliability of the overall installation.

In order to determine an individual failure rate for an individual technical operating equipment, an individualized average failure rate can be first determined for the individual technical operating equipment, wherein a type-specific average failure rate, which is dependent on the age of the operating equipment, is linked to correction factors which are formed taking account of general characteristics which are dependent on use and load. In addition, a current state or status characteristic variable for the operating equipment can be derived by a method and a device for status estimation on the basis of evident characteristic data of the operating equipment and, then, the individual failure rate can be formed by linking the determined individualized average failure rate with a status-dependent correction factor for the operating equipment.

The consideration according to an exemplary method of the type-specific average failure rate, which is dependent on the age of the operating equipment, also makes it possible to predict the failure rate to be expected at a time in the future. The use of evident characteristic data of the operating equipment also makes it possible to take account of very different influences, for example in the case of a transformer, electrical voltage or power loads, design features or typical failure rates for the design form.

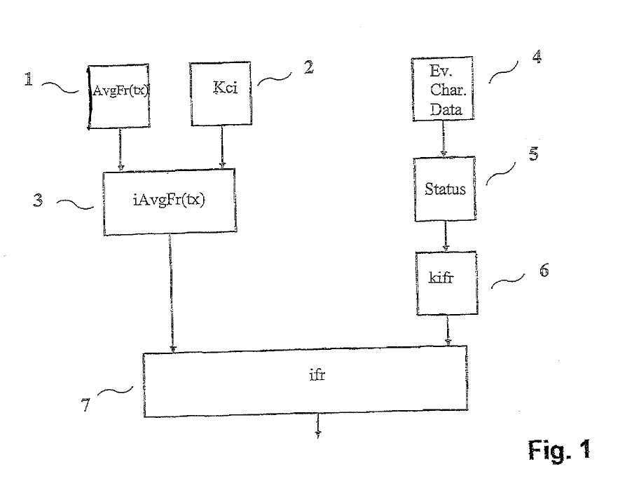

FIG. 1 shows an example of a method for determining an individual failure rate “ifr” for an individual technical operating equipment.

In this case, the reference symbol 1 denotes the formation of an average failure rate AvgFr(tx), which is specific for the operating equipment type and is dependent on the age “t” of the operating equipment.

This is based on an average failure rate AvgFr which is specific for the operating equipment type, and on a failure rate time model, which describes the dependency of the failure rate AvgFr on the age “t” of the operating equipment. The time under consideration, such as the time when the method is carried out, is denoted tx. In order to determine the average failure rate AvgFr specific for the operating equipment type and its dependency on the age of the operating equipment, statistical data can be obtained in preparation, for example from international or national organizations or societies which collate such statistical material, as well as from manufacturers and/or operators of the operating equipment type under consideration. The profile of the failure rate which is dependent on the operating equipment age may be different, for example may be constant or may correspond to the known bathtub shape, or may be a profile which for example increases non-linearly with age. The average failure rate AvgFr(tx) specific for the operating equipment type can be formed by linking the failure rate AvgFr to the selected profile of the dependency on the operating equipment age. A similar procedure can be adopted when not using the age of the operating equipment but a different characteristic value for relating to the time when the method was carried out, for example “nx”—number of operations, number of switching operations, or number of operations carried out or the like, on the basis of which the failure rate specific for the operating equipment type is AvgFr(nx).

The reference symbol 2 denotes the formation of correction factors Kci used to individualize the average failure rate AvgFr(tx) specific for the operating equipment type. First, in preparation, general characteristics ci=c1, c2, c3 to cn can be formed for this purpose, which are specific for the operating equipment type and failure-relevant. General characteristics such as these are, for example, voltage values and power values, dimensions, application, failure type—for example only electrical or only mechanical—design type, production quantities of operating equipments of the same or a similar type, or the time period of production of operating equipments of the same type. The general characteristics ci are used to modify the failure rate AvgFr(tx) by correction factors Kci=Fci(ci), where Fci is a general function, and ci is the value of the respective characteristic ci, for example the rated voltage of the operating equipment.

The reference symbol 3 denotes the linking of the average failure rate AvgFr(tx) specific for the operating equipment type to the correction factors Kci to form an individualized average failure rate iAvgFr(tx). This individualized average failure rate statistically describes the failure rate of the operating equipment type under consideration for the case of the characteristics on which the correction factors Kci are based. The individualized average failure rate iAvgFr can be calculated as follows:

iAvgFr(tx) at a time tx=AFF(AvgFr(tx), Kc1, Kc2, Kc3 . . . Kcn), wherein AFF is a general function or a mathematical algorithm, and K1, 2, 3 is the correction value for the characteristics c1, 2, 3. The calculation formula can also, for example, be:

iAvgFr at a time tx=AvgFr(tx)*Kc1*Kc2*Kc3* . . . *Kcn.

The individualized average failure rate iAvgFr(tx) formed in this way is admittedly on average applicable to one specific operating equipment type and taking account of specific characteristics, but has not yet been matched to the state of an individual operating equipment which is used in a specific environment. Further information can therefore be recorded, and used to adapt the failure rate, as will be explained in the following text.

The reference symbol 4 denotes the preparatory provision of evident data for the relevant operating equipment to be evaluated. Such major data may, for example, relate to operation, diagnosis, monitoring, sensor signals, observation, servicing, the operating environment in which the operating equipment is integrated, such as a power station or switch gear assembly, and to stress factors/load factors of whatever type, which act on the installation.

The reference symbol 5 denotes the derivative of a status-related or state-related value which relates to the individual technical operating equipment in its specific use and at the time of the evaluation. By way of example, the status value derived on the basis of the evident data provided may be a value in a defined value range from 0 to 100, where the value 0 can indicate a good state, and the value 100 a poor state. The status value can be formed by a processor means implementing different methods and algorithms, and by different weighting of the data used. The method specified in EP 1 618 524 A1 for systematic evaluation and classification of technical operating equipment can be used to derive the status value, together with the associated device, which is likewise specified there, as well.

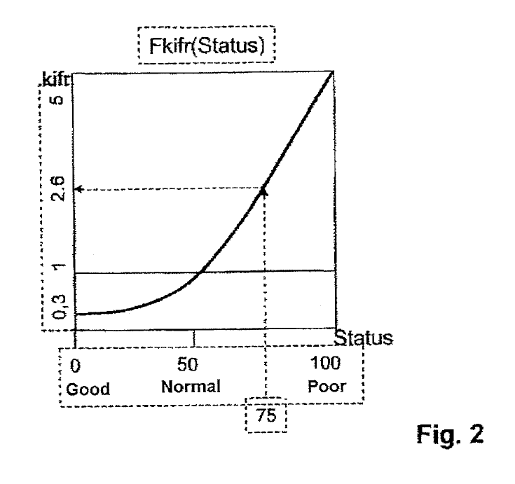

Reference symbol 6 denotes a conversion of the status value in a status-dependent correction factor kifr. By way of example, FIG. 2 shows a function Fkifr (status), corresponding to which, for example, a status value of 75 is converted to a status-dependent correction factor kifr of 2.6. The function illustrated by way of example in FIG. 2 is non-linear. A status value 50 is denoted as normal, that is to say it corresponds to the average of the operating equipment type, and leads to a status-dependent correction factor kifr with the value 1.

The reference symbol 7 denotes the calculation of the individual failure rate ifr=iAvgFr(tx)*kifr, that is to say the failure rate, which is applicable to a specific time or is to be predicted for a specific time, to be determined for the individual technical operating equipment. According to this calculation formula, a status-dependent correction factor kifr with the value 1 means that the individual failure rate ifr corresponds to the individualized average failure rate iAvgFr(tx). Correction factors greater than 1 mean a relatively poor status and result in a higher individual failure rate ifr, and correction factors with a value of less than 1 result in a lower individual failure rate ifr.

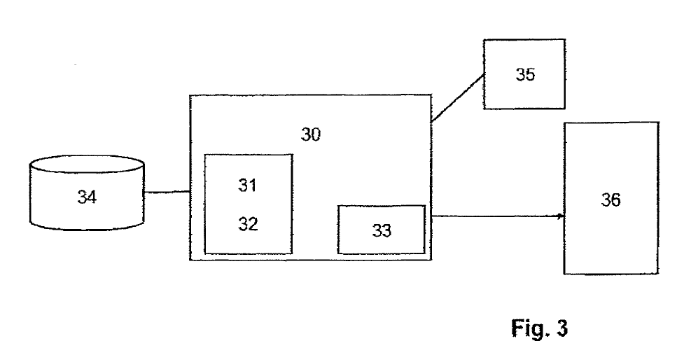

FIG. 3 shows an example of a system for determining an individual failure rate ifr for an individual technical operating equipment by means of a data processing device 30 which interacts with at least one data memory 34 and has an input/output apparatus 35. The data processing device 30 may, for example, be a PC. The data processing device 30 can be configured to provide means which allow a user not only to input specified data but also to select and configure installed programs or models, for a example to define the function Fkifr(status) shown in FIG. 2, or a function which relates to the failure rate profile, which is dependent on the operating equipment age.

The system, such as the data processing device 30, can include means 31, 32 and 33, for example so-called engines, with the aid of which the individual failure rate ifr is determined under program control after providing the statistical data, which is known for the operating equipment type, and the evident characteristic data for the individual operating equipment. For example, an ifr engine 33 can be installed which not only determines the failure rate ifr for a single operating equipment but is designed to calculate the failure rate for a group of operating equipments for a present time, or for times in the future. In addition, a status evaluation engine 31 can be installed, which is designed to determine the overall state of a specific operating equipment, possibly as well as a plurality of part aspect engines 32, which are designed to determine intermediate values or status values based on specific aspect elements.

The system can have output means which make it possible to transfer results to an external processing device 36. By way of example, such a processing device 36 can be designed to further process results within the scope of management systems, for example in order to support the planning of and decisions relating to repair or replacement of operating equipments. For example, the transferred individualized failure rates for a plurality of operating equipments can be used for reliability calculation for a complex system, or an installation such as power station.

Determined individual failure rates can also be used, for example, for so-called asset management, in order to estimate risks on a more justified basis, for example in order to determine the probability of a specific operating equipment failing within a specific time period, for example a year. Results of the ifr engine 33 can also be used for so-called mapping, for example in order to map determined failure rates, by means of a configured processor implementing any type of reliability software, onto defined areas, such as “reliable”, “degenerate” or “unreliable”.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method for determining an individual failure rate for at least one individual technical operating equipment using a data processing device to perform a computer implemented method comprising:
receiving statistical data and characteristic data which are specific for a type of technical operating equipment, at least a portion of the characteristic data being used for the individual technical operating equipment;
deriving additional characteristic data from information relating to influences resultant from a point of use and operation method of the individual technical operating equipment in an industrial installation; and
determining an individual failure rate based on the statistical data, the characteristic data and the additional characteristic data.

2. The method as claimed in claim 1, comprising, after inputting data to be used in an automated form:
determining a type-specific average failure rate based on the statistical data specific for the operating equipment type;
determining correction factors specific for the type of technical operating equipment based on the characteristic data;
forming an individualized average failure rate by linking the type-specific average failure rate to the correction factors;
determining a status value, and from the status value, determining a status-dependent correction factor based on the characteristic data of the individual technical operating equipment; and
calculating the individual failure rate by mathematically linking the individualized average failure rate to the status-dependent correction factor.

3. The method as claimed in claim 1, comprising:
determining the individual failure rate for a complex individual technical operating equipment.

4. The method as claimed in claim 1, comprising:
calculating individual failure rates for each of a group of operating equipments; and
calculating an overall failure rate for a technical installation which contains the group of operating equipments based on the individual failure rates.

5. A system for determining an individual failure rate for at least one individual technical operating equipment, comprising:
at least one data processing device; and
at least one data memory and an input/output apparatus for interaction with the data processing device, wherein the data processing device includes means for determining an individual failure rate step-by-step under computer program control based on statistical data and characteristics specific for a specified technical operating equipment type, and based on characteristic data which is applicable to an individual technical operating equipment, and based on characteristic data derived from information relating to influences resultant from a point of use and an operation method of the individual technical operating equipment in an industrial installation.

6. The system as claimed in claim 5, wherein the data processing device is configured by a computer program to perform a method of:
determining a type-specific average failure rate based on the statistical data specific for the operating equipment type;
determining correction factors specific for the operating equipment type based on the characteristics specific for the specified technical operating equipment type;
forming an individualized average failure rate by linking the type-specific average failure rate to the correction factors specific for the operating equipment type;
determining a status value, and from the status value, determining a status-dependent correction factor based on the characteristic data of the individual technical operating equipment; and
calculating the individual failure rate by mathematically linking the individualized average failure rate to the status-dependent correction factor.
